(19) United States
(12) Patent Application Publication
(10) Pub. No.: US 2025/0290771 A1
(43) Pub. Date: Sep. 18, 2025

(54) ROBOT STATE DETERMINATION

(71) Applicant: Beijing Youzhuju Network Technology Co., Ltd., Beijing (CN)

(72) Inventors: Jiafeng Xu, Beijing (CN); Guangzeng Chen, Beijing (CN); Tao Kong, Beijing (CN)

(21) Appl. No.: 19/039,133

(22) Filed: Jan. 28, 2025

(30) Foreign Application Priority Data
Mar. 18, 2024 (CN) 202410309665.4

(51) Int. Cl. G01C 22/00; B62D 57/028

(52) U.S. Cl. CPC G01C 22/00; B62D 57/028

(57) ABSTRACT

The application provides a method and apparatus for state determination of a robot, the robot and a medium, where the robot is a leg-wheel hybrid robot, and the leg-wheel hybrid robot includes an inertial sensor, a leg odometer, and a wheel odometer. The method includes: determining predicted state information of the leg-wheel hybrid robot at a current moment according to inertial data collected by the inertial sensor at the current moment; determining measurement state information of the leg-wheel hybrid robot at the current moment according to the leg odometer and the wheel odometer, respectively; and determining actual state information of the leg-wheel hybrid robot at the current moment according to the measurement state information and the predicted state information. The application can improve the accuracy of robot state determination.

### CROSS-REFERENCE

The present application claims priority to Chinese Patent Application No. 202410309665.4, filed on Mar. 18, 2024, and entitled “ROBOT STATE DETERMINATION METHOD, APPARATUS, ROBOT, AND MEDIUM”, the entirety of which is incorporated herein by reference.

### FIELD

Embodiments of the present application relate to the field of robot technologies, and in particular, to robot state determination.

### BACKGROUND

With the development of robot technologies, more and more robots are applied in fields such as service guidance and item delivery, bringing convenience to people's lives. However, during the movement of the robot, the robot may be stuck by an obstacle or slip, resulting in a relatively low accuracy of robot state determination.

### SUMMARY

Embodiments of the present application provide a robot state determination method and apparatus, a robot, and a medium, which can improve the accuracy of robot state determination.

According to a first aspect, embodiments of the present application provide a method for state determination of a robot, the robot is a leg-wheel hybrid robot, and the leg-wheel hybrid robot includes an inertial sensor, a leg odometer, and a wheel odometer. The method includes: determining predicted state information of the leg-wheel hybrid robot at a current moment according to inertial data collected by the inertial sensor at the current moment; determining measurement state information of the leg-wheel hybrid robot at the current moment according to the leg odometer and the wheel odometer, respectively; and determining actual state information of the leg-wheel hybrid robot at the current moment according to the measurement state information and the predicted state information.

According to a second aspect, embodiments of the present application provide an apparatus for state determination of a robot, the robot is a leg-wheel hybrid robot, and the leg-wheel hybrid robot includes an inertial sensor, a leg odometer, and a wheel odometer. The apparatus includes: a predicted state determination module configured to determine predicted state information of the leg-wheel hybrid robot at a current moment according to inertial data collected by the inertial sensor at the current moment; a measurement state determination module configured to determine measurement state information of the leg-wheel hybrid robot at the current moment according to the leg odometer and the wheel odometer, respectively; and an actual state determination module configured to determine actual state information of the leg-wheel hybrid robot at the current moment according to the measurement state information and the predicted state information.

According to a third aspect, embodiments of the present application provide a robot, including: a processor and a memory, where the memory is configured to store a computer program, and the processor is configured to invoke and run the computer program stored in the memory, to perform the method for state determination of the robot according to the embodiments of the first aspect.

According to a fourth aspect, an embodiment of the present application provides a computer-readable storage medium, configured to store a computer program, where the computer program causes a computer to perform the method for state determination of the robot according to the embodiments of the first aspect.

According to a fifth aspect, embodiments of the present application provide a computer program product including a program instruction, where when the program instruction runs on an electronic device, the electronic device is caused to perform the robot state determination method according to the embodiments of the first aspect.

According to the technical solution disclosed in the embodiments of the present application, the predicted state information of the leg-wheel hybrid robot at the current moment is determined according to the inertial data collected by the inertial sensor at the current moment, the measurement state information of the leg-wheel hybrid robot at the current moment is determined according to the leg odometer and the wheel odometer, respectively, and then the actual state information of the leg-wheel hybrid robot at the current moment is determined according to the measurement state information and the predicted state information. In the present application, the actual state of the robot is determined by fusing the inertial sensor data, the leg odometer data, and the wheel odometer data, thereby effectively solving the problem of an inaccurate actual state of the robot caused by error accumulation and environmental interference when the actual state of the robot is determined in a single manner, so that the accuracy of robot state determination can be improved.

### BRIEF DESCRIPTION OF THE DRAWINGS

In order to more clearly describe the technical solutions in the embodiments of the present application, the following briefly introduces the drawings required for describing the embodiments. Apparently, the drawings in the following description show merely some embodiments of the present application, and a person of ordinary skill in the art may derive other drawings from these drawings without creative efforts.

FIG. 1 is a schematic structural diagram of a leg-wheel hybrid robot according to an embodiment of the present application.

FIG. 2 is a flowchart of a robot state determination method according to an embodiment of the present application.

FIG. 3 is a flowchart of determining measurement state information of a leg-wheel hybrid robot at a current moment according to an embodiment of the present application.

FIG. 4 is a schematic diagram of a center point of rear wheels according to an embodiment of the present application.

FIG. 5 is a flowchart of another robot state determination method according to an embodiment of the present application.

FIG. 6 is a schematic block diagram of a robot state determination apparatus according to an embodiment of the present application.

FIG. 7 is a schematic block diagram of a robot according to an embodiment of the present application.

### DETAILED DESCRIPTION

The following clearly and completely describes the technical solutions in the embodiments of the present application with reference to the drawings in the embodiments of the present application. Apparently, the described embodiments are merely some embodiments of the present application, rather than all the embodiments. All other embodiments obtained by a person of ordinary skill in the art based on the embodiments of the present application without creative efforts shall fall within the protection scope of the present application.

It should be noted that the terms “first” and “second” in the description, claims, and drawings of the present application are intended to distinguish between similar objects, but do not necessarily describe a specific order or sequence. It should be understood that the data used in this manner may be interchanged in appropriate circumstances, so that the embodiments of the present application described herein may be implemented in orders other than those illustrated or described herein. In addition, the terms “include” and “have” and any variations thereof are intended to cover non-exclusive inclusion. For example, a process, method, system, product, or server that includes a series of steps or units is not necessarily limited to those steps or units clearly listed, but may include other steps or units not clearly listed or inherent to these processes, methods, products, or devices.

In the embodiments of the present application, the words “exemplary” or “for example” are used to represent an example, an illustration, or an explanation. Any embodiment or solution described as “exemplary” or “for example” in the embodiments of the present application should not be interpreted as being more preferable or advantageous than other embodiments or solutions. Rather, the words “exemplary” or “for example” are used to present related concepts in a specific manner.

In the description of the embodiments of the present application, it should be further noted that, unless otherwise clearly defined and limited, the terms “set”, “dispose”, “connected”, and “connect” should be understood in a broad sense. For example, the terms may refer to a fixed connection, a detachable connection, or an integrated connection; may refer to a mechanical connection or an electrical connection; may refer to a direct connection or an indirect connection through an intermediate medium, or may refer to an internal communication between two elements or an interaction relationship between two elements. For a person of ordinary skill in the art, the person may understand the specific meaning of the above terms in the present application according to specific situations and in conjunction with the prior art. In addition, features in the embodiments of the present application may be combined with each other without conflict. One or more of the components in the drawings may be necessary or unnecessary, and the relative positional relationship between the components shown in the above drawings may be adjusted according to actual needs.

In the description of the embodiments of the present application, unless otherwise specified, the term “a plurality of” refers to two or more, that is, at least two. “At least one” refers to one or more.

It is considered that during the movement of the robot, the robot may be stuck by an obstacle or slip, resulting in a relatively low accuracy of robot state determination. In order to solve the above technical problem, the inventive concept of the present application is to: separately determine the predicted state information of the leg-wheel hybrid robot at the current moment by using the inertial sensor provided on the leg-wheel hybrid robot, determine the measurement state information of the leg-wheel hybrid robot at the current moment by using the leg odometer and the wheel odometer respectively, and then determine the actual state information of the leg-wheel hybrid robot at the current moment according to a plurality of measurement states and a predicted state at the current moment. Therefore, the actual state of the leg-wheel hybrid robot is determined by fusing the data of the inertial sensor, the leg odometer, and the wheel odometer, thereby improving the accuracy of the actual state determination of the robot.

The technical solutions of the present application are described in detail below with reference to some embodiments. The embodiments described below may be combined with each other, and the same or similar concepts or processes may not be described in detail in some embodiments.

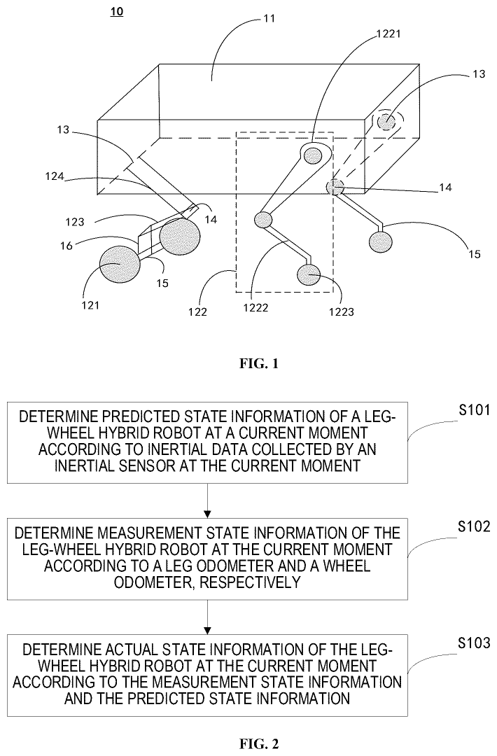

First, the structure of the leg-wheel hybrid robot in the embodiments of the present application is specifically described with reference to FIG. 1. As shown in FIG. 1, the leg-wheel hybrid robot 10 includes: a robot body 11 and four motion mechanisms disposed on the robot body 11, where the four motion mechanisms include two rear wheels 121 and two front leg mechanisms 122.

In the present application, the two front leg mechanisms 122 include a left front leg mechanism and a right front leg mechanism. Each of the front leg mechanisms 122 includes a front thigh mechanism 1221, a front shin mechanism 1222, and a wheel 1223 disposed at an end of each of the front shin mechanisms. The wheel 1223 at the end of the front shin mechanism may be understood as a passive wheel. In FIG. 1, a connecting portion between the front thigh mechanism 1221 and the robot body 11 is a hip joint 13, a connecting portion between the front thigh mechanism 1221 and the front shin mechanism 1222 is a knee joint 14, and a connecting portion between the front shin mechanism 1222 and the wheel 1223 is an ankle joint 15.

In some optional embodiments, the two rear wheels 121 are disposed at two ends of a rotatable connecting component 16, a rotatable end of the connecting component 16 is connected to one end of a rear shin mechanism 123, the other end of the rear shin mechanism 123 is connected to one end of a rear thigh mechanism 124, and the other end of the rear thigh mechanism 124 is connected to the robot body 11 (refer to FIG. 1 for details). The two rear wheels 121 may be understood as active wheels.

That is, the motion mechanisms provided on the robot body 11 in the present application include a rear leg mechanism, where the rear leg mechanism includes the rear thigh mechanism 124, the rear shin mechanism 123, the connecting component 16, and the two rear wheels 121 disposed at two ends of the connecting component 16. In the present application, a connection between the rear thigh mechanism 124 and the robot body 11 is a hip joint 13, a connection between the rear thigh mechanism 124 and the rear shin mechanism 123 is a knee joint 14, and a connection between the rear shin mechanism 124 and each of the rear wheels 121 is an ankle joint 15. That is, the rear leg mechanism in the present application includes one hip joint 13, one knee joint 14, and two ankle joints 15.

In addition, the hip joint 13, the knee joint 14, and the ankle joint 15 are each provided with a corresponding motor, specifically, a hip joint motor, a knee joint motor, and an ankle joint motor. Thus the hip joint motor, the knee joint motor, and/or the ankle joint motor output a corresponding torque to drive a change in the hip joint 13, the knee joint 14, and/or the ankle joint 15, thereby switching a motion mode of the leg-wheel hybrid robot.

Each of the joints may be understood as indicating that at least two components of the leg-wheel hybrid robot may be movably connected. In addition, each joint may move under control of a torque output by a joint motor. For example, a joint may rotate by an angle, so that other joints and related mechanisms generate a specific moving amount in space, thereby implementing a motion mode change operation of the leg-wheel hybrid robot.

Further, in order to detect different motion environments and whether there is an obstacle in a motion environment, the present application may provide at least one environment perception sensor at a front end of the robot body 11 of the leg-wheel hybrid robot 10, and provide at least one environment perception sensor at a rear end of the robot body 11, so that the leg-wheel hybrid robot can implement functions such as autonomous obstacle avoidance and mapping navigation based on the environment perception sensors.

The environment perception sensor may include, but is not limited to, a laser sensor, a visual sensor, an infrared sensor, an ultrasonic sensor, and a lidar sensor.

As an optional implementation, a visual sensor may be provided at a middle position at the front end of the robot body 11 shown in FIG. 1, a left position and a right position at the middle of the front end may be respectively provided with a lidar sensor, a laser sensor may be provided at a middle position at the rear end of the robot body 11, and a left position and a right position at the middle of the rear end may be respectively provided with an ultrasonic sensor (not shown in the figure).

It should be noted that the number, location, and type of the environment perception sensors provided on the robot body 11 in the present application are merely exemplary descriptions, and may be flexibly adjusted according to actual application requirements. The present application does not have any limitations on this.

After the structure of the leg-wheel hybrid robot is described, the robot state determination method and apparatus, the robot, and the medium provided by the embodiments of the present application are specifically described below. In the present application, the robot specifically refers to the leg-wheel hybrid robot described above with reference to FIG. 1.

FIG. 2 is a flowchart of a robot state determination method according to an embodiment of the present application. The robot state determination method provided by the embodiments of the present application may be performed by a robot state determination apparatus, and the apparatus may be composed of hardware and/or software, and may be integrated into the leg-wheel hybrid robot.

As shown in FIG. 2, the method may include the following steps.

In S101, predicted state information of the leg-wheel hybrid robot at a current moment is determined according to inertial data collected by an inertial sensor at the current moment.

In the present application, the inertial sensor may be an inertial measurement unit (abbreviated as IMU) or a device including an accelerometer, a gyroscope, and other components. The present application does not have any limitations on this.

The predicted state information of the leg-wheel hybrid robot at the current moment is specifically a priori predicted state information of the leg-wheel hybrid robot at the current moment.

Considering that the inertial sensor can collect the inertial data of the leg-wheel hybrid robot in real time, in the present application, the inertial sensor may determine the measurement state information of the leg-wheel hybrid robot at the current moment based on the inertial data collected at the current moment. The inertial data includes acceleration and angular velocity.

As an optional implementation, in the present application, the inertial data at the current moment collected by the inertial sensor may be processed according to a state transition parameter to obtain the predicted state information of the leg-wheel hybrid robot at the current moment. For details, refer to the following formula (1).

$$\check{{x}_{k}} = {F}_{k - 1} {\hat{x}}_{k - 1} + {B}_{k - 1} {ω}_{k} \qquad ( 1 )$$

where x̌ₖ is the a priori predicted state information of the leg-wheel hybrid robot at the current moment k; Fₖ₋₁ is the state transition parameter, which is used to describe prediction of the a priori predicted state at the current moment k based on the posterior actual state information of the leg-wheel hybrid robot at the previous moment k−1, and the state transition parameter is specifically a state transition matrix; \hat{x}ₖ₋₁ is the posterior actual state information of the leg-wheel hybrid robot at the previous moment k−1; Bₖ₋₁ is the control matrix determined based on an external force, which may be understood as an input state transition parameter, and is used to describe a conversion relationship between environmental noise input under the external force and the state information; and ωₖ is the inertial data at the current moment k collected by the inertial sensor. In the present application, Bₖ₋₁ may be determined in an existing manner, and the present application does not have any limitations on this.

It should be noted that when k is 0, the actual state information of the leg-wheel hybrid robot may be initialized to 0.

It should be understood that the predicted state information may include: position information, posture information, and speed information. The speed information includes linear velocity and angular velocity.

In S102, measurement state information of the leg-wheel hybrid robot at the current moment is determined according to the leg odometer and the wheel odometer, respectively.

The leg odometer and the wheel odometer belong to two different types of odometers, and are technologies used for measuring and estimating a position and a motion of a robot. Generally, rotation information of a wheel or sensor measurement data is used to calculate a displacement and a direction change of the robot. In addition, by continuously accumulating and updating the motion information, an estimation of a pose, a velocity, and the like of the robot relative to a start position may be provided.

The measurement state information of the leg-wheel hybrid robot is information obtained by performing state measurement on the leg-wheel hybrid robot.

In some optional embodiments, the leg odometer and the wheel odometer may obtain joint angle data from joint encoders corresponding to corresponding joints of the leg-wheel hybrid robot. Therefore, in the present application, the measurement state information of the leg-wheel hybrid robot at the current moment may be determined by the leg odometer based on the joint angle data at the current moment obtained from the joint encoder of the corresponding joint, and the measurement state information of the leg-wheel hybrid robot at the current moment may be determined by the wheel odometer based on the joint angle data at the current moment obtained from the joint encoder of the corresponding joint.

Considering that data communication may have a delay, when determining the measurement state information of the leg-wheel hybrid robot at the current moment, the present application may perform calculation at the current moment, or may perform calculation at several previous moments or several subsequent moments (for example, 0.05 s or 0.1 s before the current moment) of the current moment. The present application does not have any limitations on this. The several previous moments and the several subsequent moments may be flexibly set according to the data communication delay.

In the present application, the measurement state information of the leg-wheel hybrid robot may include: position information, posture information, and speed information.

In S103, the actual state information of the leg-wheel hybrid robot at the current moment is determined according to the measurement state information and the predicted state information.

Optionally, the posterior estimation covariance of the leg-wheel hybrid robot at the previous moment may be processed first by using the state transition parameter, the control matrix, and the state transition noise corresponding to the leg-wheel hybrid robot, to obtain the priori estimation covariance of the leg-wheel hybrid robot at the current moment. Then, the priori estimation covariance at the current moment is processed based on the observation matrix, the observation noise covariance matrix, and the observation noise variance, to obtain the filtering gain at the current moment. Further, the measurement state and the predicted state information of the leg-wheel hybrid robot at the current moment are fused by using an extended Kalman filter (EKF) algorithm, based on the filtering gain and the observation matrix at the current moment, to obtain the actual state information of the leg-wheel hybrid robot at the current moment.

As an optional implementation, the processing of the posterior estimation covariance of the leg-wheel hybrid robot at the previous moment by using the state transition parameter, the control matrix, and the state transition noise corresponding to the leg-wheel hybrid robot, to obtain the priori estimation covariance of the leg-wheel hybrid robot at the current moment may be implemented by using the following formula (2).

$$\check{{P}_{k}} = {F}_{k - 1} {\hat{P}}_{k - 1} {F}_{k - 1}^{T} + {B}_{k - 1} {Q}_{k} {B}_{k - 1}^{T} \qquad ( 2 )$$

where P̌ₖ is the priori estimation covariance of the leg-wheel hybrid robot at the current moment k, Fₖ₋₁ is the state transition parameter at the previous moment k−1, \hat{P}ₖ₋₁ is the posterior estimation covariance at the previous moment k−1, Fₖ₋₁^{T} is a transpose of the state transition parameter at the previous moment k−1, Bₖ₋₁ is the control matrix determined based on the external force, which may be understood as an input state transition parameter, and is used to describe a conversion relationship between the environmental noise input under the external force and the state information, Qₖ is the uncertainty of a motion environment corresponding to the current moment k, and Bₖ₋₁^{T} is a transpose of the control matrix.

In addition, the processing of the priori estimation covariance of the leg-wheel hybrid robot at the current moment based on the observation matrix, the observation noise covariance matrix, and the observation noise variance to obtain the filtering gain at the current moment may be implemented by using the following formula (3).

$${K}_{k} = {\check{P}}_{k} {{G}_{k}^{T} ( {G}_{k} {\check{P}}_{k} {G}_{k}^{T} + {C}_{k} {R}_{k} {C}_{k}^{T} )}^{- 1} \qquad ( 3 )$$

where Kₖ is the filtering gain at the current moment k, \hat{P}ₖ is the priori estimation covariance of the leg-wheel hybrid robot at the current moment k, Gₖ is the observation matrix at the current moment k, which is a matrix that maps a state matrix to an observation space and describes a relationship between a state variable and an observation variable, Gₖ^{T} is a transpose of the observation matrix Gₖ, Cₖ is the observation noise covariance matrix at the current moment k, which is used to describe statistical characteristics of the observation noise, including a variance and a covariance of an observation error, Cₖ^{T} is a transpose of the observation noise covariance matrix Cₖ, and Rₖ is the observation noise variance.

In addition, the fusing of the measurement state and the predicted state information of the leg-wheel hybrid robot at the current moment by using the EKF algorithm, based on the filtering gain and the observation matrix at the current moment, to obtain the actual state information of the leg-wheel hybrid robot at the current moment may be implemented by using the following formula (4).

$${\hat{x}}_{k} = \check{{x}_{k}} + {K}_{k} ( {y}_{k} - {G}_{k} \check{{x}_{k}} ) \qquad ( 4 )$$

where \hat{x}ₖ is the actual state information of the leg-wheel hybrid robot at the current moment k, x̌ₖ is the priori predicted state information of the leg-wheel hybrid robot at the current moment k, Kₖ is the filtering gain at the current moment k, yₖ is the measurement state information at the current moment k, and in the present application, the measurement state information includes a first measurement state determined by the leg odometer and a second measurement state determined by the wheel odometer, and Gₖ is the observation matrix at the current moment k.

That is, in the present application, the actual state information of the leg-wheel hybrid robot at the current moment is obtained by fusing the measurement state information and the predicted state information of the leg-wheel hybrid robot at the current moment.

In the present application, the actual state information may include: position information, posture information, and speed information.

In some optional embodiments, according to the structure of the leg-wheel hybrid robot shown in FIG. 1, the motion modes that may be supported by the leg-wheel hybrid robot in the present application include: a wheel motion mode and a leg-wheel hybrid motion mode. The four motion mechanisms of the leg-wheel hybrid robot include two rear wheels and two front leg mechanisms. Therefore, the rear wheels are always in the wheel motion mode, and because each of the front leg mechanisms is provided with a wheel at an end thereof, the front leg mechanism may include two motion modes: the wheel motion mode and a leg motion mode.

Correspondingly, the leg-wheel hybrid motion mode supported by the leg-wheel hybrid robot may be further classified into: a first leg-wheel hybrid motion mode obtained based on the wheel motion mode of the two rear wheels, the leg motion mode of the left front leg mechanism, and the wheel motion mode of the right front leg mechanism; a second leg-wheel hybrid motion mode obtained based on the wheel motion mode of the two rear wheels, the wheel motion mode of the left front leg mechanism, and the leg motion mode of the right front leg mechanism; and a third leg-wheel hybrid motion mode obtained based on the wheel motion mode of the two rear wheels and the leg motion mode of the two front leg mechanisms.

In order to enable the front leg mechanism to be in the leg motion mode, the present application may lock the wheel in the front leg mechanism by using a motor corresponding to an ankle joint in the front leg mechanism, so that the wheel in the front leg mechanism switches from the wheel motion mode to a supporting leg in contact with the ground, thereby ensuring that the front leg mechanism can be in the leg motion mode.

It should be understood that the above motion mode refers to a motion pattern of the leg-wheel hybrid robot.

Then, in order to determine the actual state information of the leg-wheel hybrid robot in different motion modes and different motion environments, and ensure the accuracy of the determination of the actual state information, the present application optionally sets corresponding weight values for the predicted state information determined based on the inertial data collected by the inertial sensor, the first measurement state information determined by the leg odometer, and the second measurement state information determined by the wheel odometer, respectively. For example, a first weight Z1 is set for the predicted state information, a second weight Z2 is set for the first measurement state information, and a third weight Z3 is set for the second measurement state information.

Further, the first weight Z1, the second weight Z2, and the third weight Z3 are dynamically updated based on a preset update rule according to the motion mode and the motion environment in the movement process of the leg-wheel hybrid robot, so that the actual state information of the leg-wheel hybrid robot can be accurately determined in any motion mode and motion environment.

In the present application, the preset update rule may be updating the weights according to a preset value, where the preset value is an adjustable parameter. For example, if the preset value is 0.1, the first weight Z1 and the second weight Z2 are each increased by 0.1 each time, and the third weight Z3 is reduced by 0.1. Alternatively, if the preset value is 0.2, the second weight Z2 is increased by 0.2 each time, and the first weight Z1 and the third weight Z3 are each reduced by 0.2. The present application does not have any limitations on this.

The following describes the update process of the first weight Z1, the second weight Z2, and the third weight Z3 with an example. It is assumed that before the leg-wheel hybrid robot starts to move, the first weight Z1, the second weight Z2, and the third weight Z3 are all set to X1. When the leg-wheel hybrid robot moves according to a pre-planned motion path, if it is determined that the ambient environment information is a rough terrain environment, a motion mode of the leg-wheel hybrid robot is adjusted to a leg-wheel hybrid mode in which the front leg mechanism is in the leg motion mode and the rear leg mechanism is in the wheel motion mode. In this case, it indicates that in the rough terrain environment, the accuracy of the first measurement state information determined by the leg odometer corresponding to the leg motion mode of the leg-wheel hybrid robot is higher than the accuracy of the second measurement state information determined by the wheel odometer and the accuracy of the predicted state information determined by the inertial sensor. Therefore, the second weight Z2 of the first measurement state information may be increased by 0.1 according to the preset value 0.1, and the third weight Z3 of the second measurement state information and the first weight Z1 of the predicted state information are each reduced by 0.1. Then, the leg-wheel hybrid robot continues to move. When it is determined that the ambient environment information is a flat terrain environment at the latest moment, the motion mode of the leg-wheel hybrid robot may be adjusted to a pure wheel motion mode in which the front leg mechanism is in the wheel motion mode and the rear leg mechanism is in the wheel motion mode. At this moment, in the flat terrain environment, the accuracy of the second measurement state information determined by the wheel odometer and the accuracy of the predicted state information determined based on the inertial data collected by the inertial sensor, which correspond to the wheel motion mode of the leg-wheel hybrid robot, are higher than the accuracy of the first measurement state determined by the leg odometer. In this case, the first weight X1−0.1 of the predicted state information may be increased by 0.1 according to the preset value 0.1, the third weight X1−0.1 of the second measurement state information is increased by 0.1, and the second weight X1+0.1 of the first measurement state is reduced by 0.1. The first weight Z1 corresponding to the predicted state information, the second weight Z2 of the first measurement state information, and the third weight Z3 of the second measurement state information corresponding to each moment are updated repeatedly in this manner, until the leg-wheel hybrid robot finishes moving. This configuration has the following advantage: the leg-wheel hybrid robot can use the advantages of the leg motion mode and the wheel motion mode in different terrain motion environments, so that an accurate actual state of the leg-wheel hybrid robot can always be provided, which provides favorable conditions for performing tasks such as robot motion planning, motion control, navigation, and obstacle avoidance.

In some optional embodiments, after the actual state of the leg-wheel hybrid robot at the current moment is obtained, the present application may further determine the actual state information of the leg-wheel hybrid robot at the next moment according to the actual state of the leg-wheel hybrid robot at the current moment.

Optionally, the priori estimation covariance of the leg-wheel hybrid robot at the current moment is updated based on the filtering gain at the current moment and the observation matrix at the current moment, to obtain the posterior estimation covariance of the leg-wheel hybrid robot at the current moment. Then, the foregoing robot state determination steps are repeatedly performed, and the actual state information of the leg-wheel hybrid robot at the next moment is determined based on the posterior estimation covariance and the actual state information at the current moment. Therefore, by repeating the robot state determination steps, the actual state information of the robot at each moment during the movement of the robot can be determined.

The foregoing updating of the priori estimation covariance of the leg-wheel hybrid robot at the current moment based on the filtering gain at the current moment and the observation matrix at the current moment, to obtain the posterior estimation covariance of the leg-wheel hybrid robot at the current moment may be implemented by using the following formula (5).

$${\hat{P}}_{k} = ( I - {K}_{k} {G}_{k} ) {\check{P}}_{k} \qquad ( 5 )$$

where \hat{P}ₖ is the posterior estimation covariance at the current moment k, I is an identity matrix, Kₖ is the filtering gain at the current moment k, Gₖ is the observation matrix at the current moment k, and P̌ₖ is the priori estimation covariance at the current moment k.

It should be noted that the robot in the present application may also be a wheeled robot, and the wheeled robot is provided with an inertial sensor and a wheel odometer. The inertial sensor data and the wheel odometer data are fused based on the foregoing state determination steps, to obtain the actual state information of the wheeled robot at the current moment and the next moment.

In addition, the robot in the present application may also be a legged robot, such as a quadruped robot, a biped robot, or a humanoid robot. In addition, the robot is provided with an inertial sensor and a leg odometer. The inertial sensor data and the leg odometer data are fused based on the foregoing state determination steps, to obtain the actual state information of the legged robot at the current moment and the next moment.

According to the technical solution disclosed in the embodiments of the present application, the predicted state information of the leg-wheel hybrid robot at the current moment is determined according to the inertial data collected by the inertial sensor at the current moment, the measurement state information of the leg-wheel hybrid robot at the current moment is determined according to the leg odometer and the wheel odometer, respectively, and then the actual state information of the leg-wheel hybrid robot at the current moment is determined according to the measurement state information and the predicted state information. In the present application, the actual state of the robot is determined by fusing the inertial sensor data, the leg odometer data, and the wheel odometer data, thereby effectively solving the problem of an inaccurate actual state of the robot caused by error accumulation and environmental interference when the actual state of the robot is determined in a single manner, so that the accuracy of robot state determination can be improved.

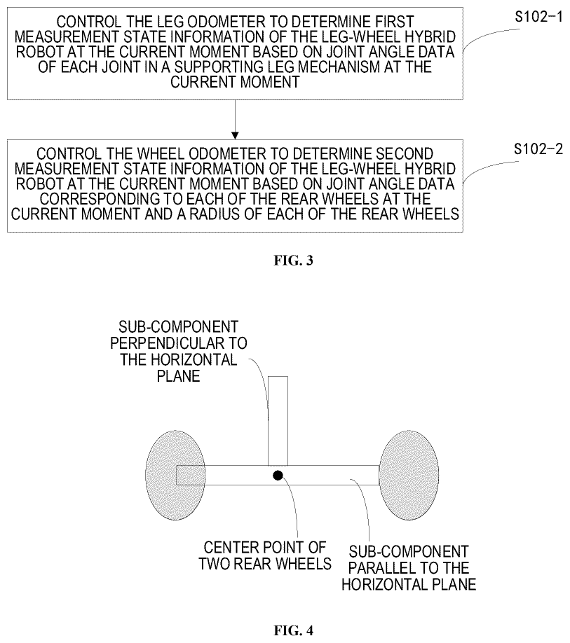

Based on the foregoing embodiments, the following further describes the determination of the measurement state information of the leg-wheel hybrid robot at the current moment according to the leg odometer and the wheel odometer respectively in the present application with reference to FIG. 3. As shown in FIG. 3, the foregoing step S102 may include the following steps.

In S102-1, the leg odometer is controlled to determine first measurement state information of the leg-wheel hybrid robot at the current moment based on joint angle data of each joint in a supporting leg mechanism at the current moment.

Considering that when the front leg mechanism of the leg-wheel hybrid robot is in the leg motion mode, motions of the left front leg mechanism and the right front leg mechanism are similar to a walking gait of a person. That is, in each motion cycle, one front leg mechanism is off the ground and in a levitation state, and the other front leg mechanism is in contact with the ground and in a supporting state. The front leg mechanism that is off the ground and in the levitation state may be referred to as a levitation leg mechanism, and the front leg structure that is in contact with the ground and in the supporting state may be referred to as a supporting leg mechanism. Correspondingly, the levitation leg mechanism corresponds to a levitation leg, and the supporting leg mechanism corresponds to a supporting leg.

In addition, each joint in each of the front leg mechanisms corresponds to a joint encoder, and each joint encoder stores angle data of the corresponding joint. In addition, the supporting leg corresponding to the supporting leg mechanism that is in contact with the ground and in the supporting state is assumed to be unchanged on the ground, that is, the supporting leg is always in contact with the ground and is assumed to be not slipping. Therefore, in the present application, the first joint angle data at the current moment may be obtained from the joint encoder corresponding to each joint in the supporting leg mechanism by using the leg odometer. A plurality of pieces of the first joint angle data exist, and specifically include: hip joint angle data, knee joint angle data, and ankle joint angle data. Then, the first measurement state information of the leg-wheel hybrid robot at the current moment is determined according to the plurality of pieces of the first joint angle data.

In some optional embodiments, the joint angle data stored in the joint encoder may be understood as a joint position. Therefore, in the present application, the first measurement state information of the leg-wheel hybrid robot at the current moment is determined according to the plurality of pieces of the first joint angle data. Optionally, a difference operation is performed on each piece of the first joint angle data to obtain an actual speed (namely, a joint speed) of each of the first joints. Then, a moving speed of the robot body of the leg-wheel hybrid robot relative to the supporting leg corresponding to the supporting leg mechanism at the current moment is calculated according to the joint position and the joint speed of each joint in the supporting leg mechanism.

In addition, the ankle joint angle data is obtained from the plurality of pieces of the first joint angle data, and then pose information of the robot body of the leg-wheel hybrid robot relative to the supporting leg corresponding to the supporting leg mechanism at the current moment is calculated by using a forward kinematics (FK) algorithm, based on the ankle joint angle data. The pose information includes position information and posture information.

In the present application, the foregoing implementation process of calculating the moving speed of the robot body of the leg-wheel hybrid robot relative to the supporting leg corresponding to the supporting leg mechanism according to the joint position and the joint speed of each joint in the supporting leg mechanism is: calculating a Jacobian matrix according to the joint positions of all joints in the supporting leg mechanism, and then calculating a product of the Jacobian matrix and the joint speed of each joint to obtain a moving speed of the supporting leg corresponding to the supporting leg mechanism relative to the robot body. Further, the moving speed of the supporting leg corresponding to the supporting leg mechanism relative to the robot body is multiplied by −1, to obtain the moving speed of the robot body relative to the supporting leg corresponding to the supporting leg mechanism.

Optionally, the foregoing calculation of the moving speed of the robot body of the leg-wheel hybrid robot relative to the supporting leg corresponding to the supporting leg mechanism may be implemented by using the following formula (6).

$$( {J}_{k} \cdot {\dot{q}}_{k} ) * - 1 = {v}_{k} \qquad ( 6 )$$

where Jₖ is the Jacobian matrix calculated according to the joint positions of all joints in the supporting leg mechanism that is in the supporting state at the current moment k, \dot{q}ₖ is the joint speed of each joint in the supporting leg mechanism that is in the supporting state at the current moment k, and vₖ is the moving speed of the robot body relative to the supporting leg corresponding to the supporting leg mechanism at the current moment k.

In addition, in the present application, the pose information of the robot body of the leg-wheel hybrid robot relative to the supporting leg corresponding to the supporting leg mechanism at the current moment is calculated by using the forward kinematics algorithm, based on the ankle joint angle data. This may be implemented by using the following formula (7).

$${}^{body} {P}_{foot} = FK ( q ) \qquad ( 7 )$$

where ^{body}P_{foot} is the pose information of the robot body of the leg-wheel hybrid robot relative to the supporting leg corresponding to the supporting leg mechanism at the current moment k, FK( ) is the forward kinematics algorithm, and q is the ankle joint angle data.

Considering that a conversion relationship between a supporting leg coordinate system and a world coordinate system of the leg-wheel hybrid robot is known or may be calculated by using a conversion algorithm, in the present application, after the measurement state information of the robot body of the leg-wheel hybrid robot relative to the supporting leg corresponding to the supporting leg mechanism is obtained, the measurement state information of the robot body relative to the supporting leg corresponding to the supporting leg mechanism may be converted into measurement state information of the robot body relative to the world coordinate system, based on the conversion relationship between the supporting leg coordinate system and the world coordinate system, to obtain the first measurement state information of the robot body in the world coordinate system. Further, the first measurement state information of the robot body in the world coordinate system is determined as the first measurement state information of the leg-wheel hybrid robot at the current moment.

In S102-2, the wheel odometer is controlled to determine second measurement state information of the leg-wheel hybrid robot at the current moment based on joint angle data corresponding to each of the rear wheels and a radius of each of the rear wheels at the current moment.

In the present application, the rear leg mechanism of the leg-wheel hybrid robot includes two rear wheels, a rear thigh mechanism, a rear shin mechanism that are shared by the two rear wheels, and a connecting component that is provided with the two rear wheels. For the rear wheels of the leg-wheel hybrid robot, because the rear wheels are always on the ground, it is assumed that the rear wheels are in pure rolling with the ground. Therefore, in the present application, second joint angle data corresponding to each of the rear wheels at the current moment may be obtained from the joint encoder corresponding to each of the rear wheels by using the wheel odometer. In addition, the radius of each of the rear wheels is obtained from configuration information of the leg-wheel hybrid robot. Further, the second measurement state information of the leg-wheel hybrid robot at the current moment is determined according to the second joint angle data corresponding to each of the rear wheels and the radius of each of the rear wheels.

A plurality of pieces of the second joint angle data respectively correspond to the first rear wheel and the second rear wheel. Specifically, the second joint angle data corresponding to the first rear wheel includes: hip joint angle data, knee joint angle data, and ankle joint angle data corresponding to the first rear wheel. The second joint angle data corresponding to the second rear wheel includes: hip joint angle data, knee joint angle data, and ankle joint angle data corresponding to the second rear wheel.

In some optional embodiments, the second measurement state information of the leg-wheel hybrid robot at the current moment may be determined according to the second joint angle data corresponding to each of the rear wheels and the radius of each of the rear wheels. A specific implementation process is as follows. A distance by which each of the rear wheels rolls on the ground may be calculated first by using the following formula (8).

$${D}_{m} = {q}_{m} \times {r}_{m} \qquad ( 8 )$$

where Dₘ is a distance by which the m-th rear wheel at the current moment k rolls on the ground, qₘ is the second joint angle data corresponding to the m-th rear wheel at the current moment k, and rₘ is a radius of the m-th rear wheel, where mϵ[1, 2].

The two rear wheels are under differential gear train constraint. Therefore, a distance by which a center point of the two rear wheels actually moves on the ground is calculated based on the distance by which each of the rear wheels rolls on the ground. Further, a moving speed of the center point of the two rear wheels relative to the robot body is calculated based on the distance by which the center point of the two rear wheels actually moves on the ground and a difference between the previous moment and the current moment. Then, the moving speed of the center point of the two rear wheels relative to the robot body is multiplied by −1, to obtain a moving speed of the robot body of the leg-wheel hybrid robot relative to the center point of the two rear wheels at the current moment.

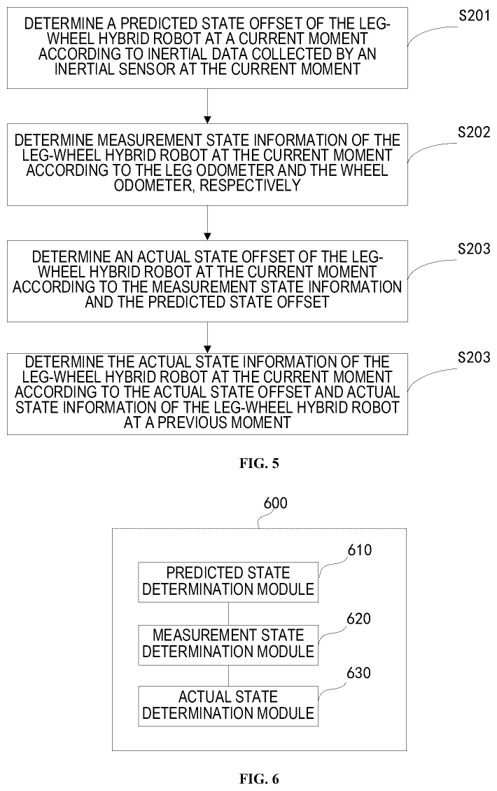

The center point of the two rear wheels may be a center point of the connecting component with the rear wheels provided at two ends thereof, or may be a center point of a sub-component parallel to the horizontal plane in the connecting component provided with the two rear wheels, as shown in FIG. 4.

In addition, in the present application, pose information of the robot body of the leg-wheel hybrid robot relative to the center point of the two rear wheels at the current moment may further be calculated by using the forward kinematics algorithm, based on the distance by which the center point of the two rear wheels actually rolls on the ground.

Considering that a conversion relationship between a coordinate system (a local coordinate system) corresponding to the center point of the two rear wheels and the world coordinate system of the leg-wheel hybrid robot is known or may be calculated by using a conversion algorithm, in the present application, after the measurement state information of the robot body of the leg-wheel hybrid robot relative to the center point of the two rear wheels is obtained, the measurement state information of the robot body relative to the center point of the two rear wheels may be converted into the measurement state information of the robot body relative to the world coordinate system, based on the conversion relationship between the local coordinate system and the world coordinate system, to obtain the second measurement state information of the robot body in the world coordinate system. Further, the second measurement state information of the robot body in the world coordinate system is determined as the second measurement state information of the leg-wheel hybrid robot at the current moment.

It should be noted that the execution sequence of S102-1 and S102-2 may be to first execute S102-1 and then execute S102-1; or may be to first execute S101-2 and then execute S101-1; or may be to synchronously execute S101-1 and S101-2. The present application does not have any limitations on this.

That is, in the present application, the plurality of pieces of measurement state information of the leg-wheel hybrid robot at the current moment may be determined by the leg odometer and the wheel odometer on the leg-wheel hybrid robot, respectively, and then the actual state of the leg-wheel hybrid robot at the current moment may be accurately determined based on the plurality of pieces of measurement state information and the predicted state information, thereby providing favorable conditions for performing tasks such as robot motion planning, motion control, navigation, and obstacle avoidance.

In another optional implementation, when determining the actual state information of the leg-wheel hybrid robot at the current moment, the present application may further determine the actual state information based on a predicted state offset. The following specifically describes the determination of the actual state information of the leg-wheel hybrid robot at the current moment with reference to FIG. 5.

As shown in FIG. 5, the method may include the following steps.

In S201, a predicted state offset of the leg-wheel hybrid robot at a current moment is determined according to inertial data collected by an inertial sensor at the current moment.

In the present application, the predicted state offset of the leg-wheel hybrid robot at the current moment is specifically a priori predicted state offset of the leg-wheel hybrid robot at the current moment. In addition, the predicted state offset may be understood as a predicted state increment.

In some optional embodiments, the inertial data at the current moment collected by the inertial sensor may be processed according to the state transition parameter, to obtain the predicted state offset of the leg-wheel hybrid robot at the current moment. This may be specifically implemented by using the following formula (9).

$$δ \check{{x}_{k}} = {F}_{k - 1} δ {\hat{x}}_{k - 1} + {B}_{k - 1} {ω}_{k} \qquad ( 9 )$$

where δx̌ₖ is the priori predicted state offset of the leg-wheel hybrid robot at the current moment k, Fₖ₋₁ is the state transition parameter, which is used to describe prediction of the priori predicted state at the current moment k based on the posterior actual state information of the leg-wheel hybrid robot at the previous moment k−1, and the state transition parameter is specifically a state transition matrix; δ\hat{x}ₖ₋₁ is a posterior actual state offset of the leg-wheel hybrid robot at the previous moment k−1; Bₖ₋₁ is the control matrix determined based on the external force, which may be understood as the input state transition parameter, and is used to describe the conversion relationship between the environmental noise input under the external force and the state information; and ωₖ is the inertial data at the current moment k collected by the inertial sensor.

In S202, the measurement state information of the leg-wheel hybrid robot at the current moment is determined according to the leg odometer and the wheel odometer, respectively.

In S203, the actual state offset of the leg-wheel hybrid robot at the current moment is determined according to the measurement state information and the predicted state offset.

In some optional embodiments, the posterior estimation covariance of the leg-wheel hybrid robot at the previous moment may be processed first by using the state transition parameter, the control matrix, and the state transition noise corresponding to the leg-wheel hybrid robot, to obtain the priori estimation covariance of the leg-wheel hybrid robot at the current moment. Then, the priori estimation covariance at the current moment is processed based on the observation matrix, the observation noise covariance matrix, and the observation noise variance, to obtain the filtering gain at the current moment. Further, the measurement state and the predicted state offset of the leg-wheel hybrid robot at the current moment are fused by using the EKF algorithm, based on the filtering gain and the observation matrix at the current moment, to obtain the actual state offset of the leg-wheel hybrid robot at the current moment.

The actual state offset may be understood as an actual state increment.

The implementation principle of determining the priori estimation covariance of the leg-wheel hybrid robot at the current moment and the filtering gain at the current moment is the same as that of step S103 in the foregoing embodiments. For a specific implementation process, refer to the part of the foregoing step S103. Details are not described herein again.

As an optional implementation, the fusing of the measurement state and the predicted state offset of the leg-wheel hybrid robot at the current moment by using the EKF algorithm, based on the filtering gain and the observation matrix at the current moment, to obtain the actual state offset of the leg-wheel hybrid robot at the current moment may be implemented by using the following formula (10).

$$δ {\hat{x}}_{k} = δ \check{{x}_{k}} + {K}_{k} ( {y}_{k} - {G}_{k} δ \check{{x}_{k}} ) \qquad ( 10 )$$

where δ\hat{x}ₖ is the actual state offset of the leg-wheel hybrid robot at the current moment k, δx̌ₖ is the priori predicted state offset of the leg-wheel hybrid robot at the current moment k, Kₖ is the filtering gain at the current moment k, yₖ is the measurement state information at the current moment k, and in the present application, the measurement state includes the first measurement state determined by the leg odometer and the second measurement state determined by the wheel odometer, and Gₖ is the observation matrix at the current moment k.

That is, in the present application, the actual state offset of the leg-wheel hybrid robot at the current moment is obtained based on the measurement state information and the predicted state offset of the leg-wheel hybrid robot at the current moment.

In S204, the actual state information of the leg-wheel hybrid robot at the current moment is determined according to the actual state offset and the actual state information of the leg-wheel hybrid robot at the previous moment.

After the actual state offset of the leg-wheel hybrid robot at the current moment is obtained, in the present application, the actual state offset may be added to the actual state information at the previous moment, to obtain the actual state information of the leg-wheel hybrid robot at the current moment.

According to the technical solution disclosed in the embodiments of the present application, the predicted state offset of the leg-wheel hybrid robot at the current moment is determined according to the inertial data collected by the inertial sensor at the current moment, the measurement state information of the leg-wheel hybrid robot at the current moment is determined according to the leg odometer and the wheel odometer, respectively, the actual state offset of the leg-wheel hybrid robot at the current moment is determined according to the measurement state information and the predicted state offset, and then the actual state information of the leg-wheel hybrid robot at the current moment is determined according to the actual state offset and the actual state information of the leg-wheel hybrid robot at the previous moment. In the present application, the actual state of the robot is determined by fusing the inertial sensor data, the leg odometer data, and the wheel odometer data, thereby effectively solving the problem of an inaccurate actual state of the robot caused by error accumulation and environmental interference when the actual state of the robot is determined in a single manner, so that the accuracy of robot state determination can be improved. In addition, the actual state offset is determined, and the actual state information of the leg-wheel hybrid robot is determined based on the actual state offset. This is simpler and faster than the determination of the actual state information.

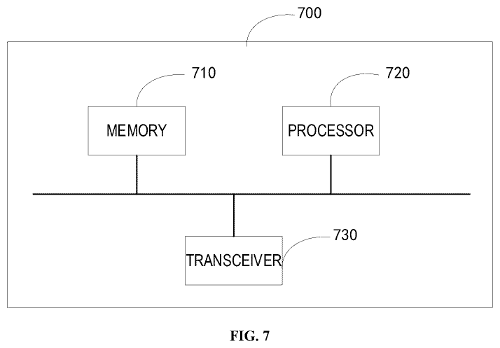

The following describes a robot state determination apparatus according to an embodiment of the present application with reference to FIG. 6. FIG. 6 is a schematic block diagram of a robot state determination apparatus according to an embodiment of the present application. The robot in the present application is a leg-wheel hybrid robot, and the leg-wheel hybrid robot includes an inertial sensor, a leg odometer, and a wheel odometer.

As shown in FIG. 6, the robot state determination apparatus 600 includes: a predicted state determination module 610, a measurement state determination module 620, and an actual state determination module 630.

The predicted state determination module 610 is configured to determine predicted state information of the leg-wheel hybrid robot at a current moment according to inertial data collected by the inertial sensor at the current moment.

The measurement state determination module 620 is configured to determine measurement state information of the leg-wheel hybrid robot at the current moment according to the leg odometer and the wheel odometer, respectively.

The actual state determination module 630 is configured to determine actual state information of the leg-wheel hybrid robot at the current moment according to the measurement state information and the predicted state information.

According to an optional implementation of the embodiments of the present application, the predicted state determination module 610 is specifically configured to: process the inertial data at the current moment collected by the inertial sensor according to a state transition parameter to obtain the predicted state information of the leg-wheel hybrid robot at the current moment.

According to an optional implementation of the embodiments of the present application, the leg-wheel hybrid robot further includes four motion mechanisms, where the four motion mechanisms include two rear wheels and two front leg mechanisms, and the measurement state determination module 620 includes: a first determination unit configured to control the leg odometer to determine first measurement state information of the leg-wheel hybrid robot at the current moment based on joint angle data of each joint in a supporting leg mechanism at the current moment; and a second determination unit configured to control the wheel odometer to determine second measurement state information of the leg-wheel hybrid robot at the current moment based on joint angle data corresponding to each of the rear wheels at the current moment and a radius of each of the rear wheels.

According to an optional implementation of the embodiments of the present application, the first determination unit is specifically configured to: obtain first joint angle data at the current moment from a joint encoder corresponding to each joint in the supporting leg mechanism by using the leg odometer, and determine the first measurement state information of the leg-wheel hybrid robot at the current moment according to the first joint angle data.

According to an optional implementation of the embodiments of the present application, the second determination unit is specifically configured to: obtain second joint angle data corresponding to each of the rear wheels at the current moment from a joint encoder corresponding to each of the rear wheels by using the wheel odometer; obtain the radius of each of the rear wheels; and determine the second measurement state information of the leg-wheel hybrid robot at the current moment according to the second joint angle data corresponding to each of the rear wheels and the radius of each of the rear wheels.

According to an optional implementation of the embodiments of the present application, the actual state determination module 630 is specifically configured to fuse the measurement state information and the predicted state information, to obtain the actual state information of the leg-wheel hybrid robot at the current moment.

According to an optional implementation of the embodiments of the present application, the measurement state information, the actual state information, the predicted state information, and the actual state information respectively include: position information, posture information, and speed information.

According to an optional implementation of the embodiments of the present application, the actual state determination module 630 is specifically configured to: determine a predicted state offset of the leg-wheel hybrid robot at the current moment according to the inertial data collected by the inertial sensor at the current moment; determine an actual state offset of the leg-wheel hybrid robot at the current moment according to the measurement state information and the predicted state offset; and determine the actual state information of the leg-wheel hybrid robot at the current moment according to the actual state offset and the actual state information of the leg-wheel hybrid robot at the previous moment.

According to an optional implementation of the embodiments of the present application, the actual state determination module 630 is further configured to: determine the actual state information of the leg-wheel hybrid robot at the next moment according to the actual state information of the leg-wheel hybrid robot at the current moment.

It should be understood that the apparatus embodiments may correspond to the foregoing method embodiments, and for similar descriptions, reference may be made to the method embodiments. To avoid repetition, details are not described herein again. Specifically, the apparatus 600 shown in FIG. 6 may perform the method embodiments corresponding to FIG. 2, and the foregoing and other operations and/or functions of the modules in the apparatus 600 are respectively to implement corresponding processes in the methods in FIG. 2. For brevity, details are not described herein again.

The apparatus 600 according to the embodiments of the present application is described above from the perspective of functional modules with reference to the drawings. It should be understood that the functional module may be implemented in the form of hardware, or in the form of software instructions, or in the form of a combination of hardware and software modules. Specifically, steps of the method embodiments of the first aspect in the embodiments of the present application may be completed by integrated logic circuits of hardware in the processor and/or instructions in the form of software. Steps of the method of the first aspect disclosed in the embodiments of the present application may be directly implemented as being completed by a hardware decoding processor, or may be implemented as being completed by a combination of hardware and a software module in a decoding processor. Optionally, the software module may be located in a mature storage medium in the art, such as a random access memory, a flash memory, a read-only memory, a programmable read-only memory, an electrically erasable programmable read-only memory, and a register. The storage medium is located in the memory, and the processor reads information in the memory, and completes the steps in the method embodiments of the first aspect in combination with the hardware.

FIG. 7 is a schematic block diagram of a robot according to an embodiment of the present application. As shown in FIG. 7, the robot 700 may include: a memory 710 and a processor 720. The memory 710 is configured to store a computer program and transmit the program code to the processor 720. In other words, the processor 720 may invoke and run the computer program from the memory 710, to implement the robot state determination method in the embodiments of the present application.

For example, the processor 720 may be configured to perform the above robot state determination method according to instructions in the computer program.

In some embodiments of the present application, the processor 720 may include, but is not limited to: a general-purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logic device, a discrete gate or transistor logic device, a discrete hardware component, and the like.

In some embodiments of the present application, the memory 710 includes, but is not limited to: a volatile memory and/or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which is used as an external cache. By way of example but not limitation, many forms of RAM may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (synch link DRAM, SLDRAM), and a direct rambus random access memory (Direct Rambus RAM, DR RAM).

In some embodiments of the present application, the computer program may be divided into one or more modules, the one or more modules are stored in the memory 710 and executed by the processor 720, to perform the robot state determination method provided in the present application. The one or more modules may be a series of computer program instruction segments capable of performing a specific function, and the instruction segments are used to describe an execution process of the computer program in the electronic device.

As shown in FIG. 7, the robot 700 may further include: a transceiver 730. The transceiver 730 may be connected to the processor 720 or the memory 710.

The processor 720 may control the transceiver 730 to communicate with another device. Specifically, the transceiver 730 may send information or data to the another device, or receive information or data sent by the another device. The transceiver 730 may include a transmitter and a receiver. The transceiver 730 may further include an antenna, and the antenna may be one or more.

It should be understood that components in the robot are connected by a bus system, and the bus system includes a power supply bus, a control bus, and a status signal bus in addition to a data bus.

The present application further provides a computer storage medium, which stores a computer program, and the computer program, when executed by a computer, causes the computer to perform the robot state determination method according to the foregoing embodiments.

An embodiment of the present application further provides a computer program product including a program instruction. When the program instruction runs on an electronic device, the electronic device is caused to perform the robot state determination method according to the foregoing embodiments.

When software is used for implementation, the method may be implemented entirely or partially in the form of a computer program product. The computer program product includes one or more computer instructions. When the computer program instructions are loaded and executed on a computer, the procedures or functions according to the embodiments of the present application are entirely or partially generated. The computer may be a general-purpose computer, a special-purpose computer, a computer network, or another programmable apparatus. The computer instructions may be stored in a computer-readable storage medium, or may be transmitted from one computer-readable storage medium to another computer-readable storage medium. For example, the computer instructions may be transmitted from a website, a computer, a server, or a data center to another website, computer, server, or data center in a wired manner (for example, using a coaxial cable, an optical fiber, or a digital subscriber line (DSL)) or a wireless manner (for example, infrared, wireless, or microwave). The computer-readable storage medium may be any usable medium accessible by the computer or a data storage device, such as a server or a data center, that includes one or more usable media. The usable medium may be a magnetic medium (for example, a floppy disk, a hard disk, or a magnetic tape), an optical medium (for example, a digital video disc (DVD)), or a semiconductor medium (for example, a solid-state disk (SSD)).

A person of ordinary skill in the art may be aware that modules and algorithm steps of various examples described in the embodiments disclosed herein may be implemented in electronic hardware, computer software, or a combination thereof. Whether these functions are performed in hardware or software depends on particular applications and design constraints of the technical solutions. Professionals may use different methods to implement the described functions for each particular application, but such implementation should not be considered to be beyond the scope of the present application.

In the several embodiments provided in the present application, it should be understood that the disclosed system, apparatus and method may be implemented in other manners. For example, the above described apparatus embodiments are merely illustrative, for example, the division of modules is merely a logical function division, and in actual implementation, there may be other division manners, for example, multiple modules or components may be combined or integrated into another system, or some features may be ignored or not performed. In addition, the mutual coupling or direct coupling or communication connection shown or discussed may be indirect coupling or communication connection through some interfaces, apparatuses or modules, which may be electrical, mechanical or other forms.

The modules described as separate components may be or may not be physically separated, and the components shown as modules may be or may not be physical modules, that is, may be located in one place, or may be distributed to a plurality of network units. Part or all of the modules may be selected according to actual needs to achieve the purpose of the solution of the embodiments. For example, the functional modules in the embodiments of the present application may be integrated in a processing module, or each module may exist physically alone, or two or more modules may be integrated into one module.

In the embodiments of the present application, the term “module” or “unit” refers to a computer program with a predetermined function or a part of a computer program, and the module or unit works with other related parts to achieve a predetermined target, and may be implemented entirely or partially by using software, hardware (such as a processing circuit or a memory), or a combination thereof. Similarly, a processor (or multiple processors or a memory) may be used to implement one or more modules or units. In addition, each module or unit may be a part of an overall module or unit that contains the function of the module or unit.

The above is only a specific implementation of the present application, but the protection scope of the present application is not limited to this. Any person skilled in the art can easily think of changes or replacements within the technical scope disclosed in the present application, which should be covered in the protection scope of the present application. Therefore, the protection scope of the present application should be subject to the protection scope of the claims.

1. A method for state determination of a robot, wherein the robot is a leg-wheel hybrid robot, and the leg-wheel hybrid robot comprises an inertial sensor, a leg odometer, and a wheel odometer, the method comprising:
determining predicted state information of the leg-wheel hybrid robot at a current moment according to inertial data collected by the inertial sensor at the current moment;
determining measurement state information of the leg-wheel hybrid robot at the current moment according to the leg odometer and the wheel odometer, respectively; and
determining actual state information of the leg-wheel hybrid robot at the current moment according to the measurement state information and the predicted state information.

2. The method according to claim 1, wherein the determining the predicted state information of the leg-wheel hybrid robot at the current moment according to the inertial data collected by the inertial sensor at the current moment comprises:
processing the inertial data at the current moment collected by the inertial sensor according to a state transition parameter to obtain the predicted state information of the leg-wheel hybrid robot at the current moment.

3. The method according to claim 1, wherein the leg-wheel hybrid robot further comprises four motion mechanisms, the four motion mechanisms comprise two rear wheels and two front leg mechanisms, and determining the measurement state information of the leg-wheel hybrid robot at the current moment comprises:
controlling the leg odometer to determine first measurement state information of the leg-wheel hybrid robot at the current moment based on joint angle data of each joint in a supporting leg mechanism at the current moment; and
controlling the wheel odometer to determine second measurement state information of the leg-wheel hybrid robot at the current moment based on joint angle data corresponding to each of the rear wheels at the current moment and a radius of each of the rear wheels.

4. The method according to claim 3, wherein controlling the leg odometer to determine the first measurement state information of the leg-wheel hybrid robot at the current moment based on the joint angle data of each joint in the supporting leg mechanism at the current moment comprises:
obtaining first joint angle data at the current moment from a joint encoder corresponding to each joint in the supporting leg mechanism by using the leg odometer, and determining the first measurement state information of the leg-wheel hybrid robot at the current moment according to the first joint angle data.

5. The method according to claim 3, wherein controlling the wheel odometer to determine the second measurement state information of the leg-wheel hybrid robot at the current moment based on the joint angle data corresponding to each of the rear wheels at the current moment and the radius of each of the rear wheels comprises:
obtaining second joint angle data corresponding to each of the rear wheels at the current moment from a joint encoder corresponding to each of the rear wheels by using the wheel odometer;
obtaining the radius of each of the rear wheels; and
determining the second measurement state information of the leg-wheel hybrid robot at the current moment according to the second joint angle data corresponding to each of the rear wheels and the radius of each of the rear wheels.

6. The method according to claim 1, wherein determining the actual state information of the leg-wheel hybrid robot at the current moment according to the measurement state information and the predicted state information comprises:
fusing the measurement state information and the predicted state information to obtain the actual state information of the leg-wheel hybrid robot at the current moment.

7. The method according to claim 1, wherein the measurement state information, the actual state information, the predicted state information, and the actual state information respectively comprise: position information, posture information, and speed information.

8. The method according to claim 1, wherein determining the actual state information of the leg-wheel hybrid robot at the current moment comprises:
determining a predicted state offset of the leg-wheel hybrid robot at the current moment according to the inertial data collected by the inertial sensor at the current moment;
determining an actual state offset of the leg-wheel hybrid robot at the current moment according to the measurement state information and the predicted state offset; and
determining the actual state information of the leg-wheel hybrid robot at the current moment according to the actual state offset and actual state information of the leg-wheel hybrid robot at a previous moment.

9. The method according to claim 1, further comprising:
determining actual state information of the leg-wheel hybrid robot at a next moment according to the actual state information of the leg-wheel hybrid robot at the current moment.

10. A robot, wherein the robot is a leg-wheel hybrid robot comprising an inertial sensor, a leg odometer, and a wheel odometer and the robot further comprises:
a processor and a memory, wherein the memory is configured to store a computer program, and the processor is configured to invoke and run the computer program stored in the memory, to perform acts comprising:
determining predicted state information of the leg-wheel hybrid robot at a current moment according to inertial data collected by the inertial sensor at the current moment;
determining measurement state information of the leg-wheel hybrid robot at the current moment according to the leg odometer and the wheel odometer, respectively; and
determining actual state information of the leg-wheel hybrid robot at the current moment according to the measurement state information and the predicted state information.

11. The robot according to claim 10, wherein the determining the predicted state information of the leg-wheel hybrid robot at the current moment according to the inertial data collected by the inertial sensor at the current moment comprises:
processing the inertial data at the current moment collected by the inertial sensor according to a state transition parameter to obtain the predicted state information of the leg-wheel hybrid robot at the current moment.

12. The robot according to claim 10, wherein the leg-wheel hybrid robot further comprises four motion mechanisms, the four motion mechanisms comprise two rear wheels and two front leg mechanisms, and determining the measurement state information of the leg-wheel hybrid robot at the current moment comprises:
controlling the leg odometer to determine first measurement state information of the leg-wheel hybrid robot at the current moment based on joint angle data of each joint in a supporting leg mechanism at the current moment; and
controlling the wheel odometer to determine second measurement state information of the leg-wheel hybrid robot at the current moment based on joint angle data corresponding to each of the rear wheels at the current moment and a radius of each of the rear wheels.

13. The robot according to claim 12, wherein controlling the leg odometer to determine the first measurement state information of the leg-wheel hybrid robot at the current moment based on the joint angle data of each joint in the supporting leg mechanism at the current moment comprises:
obtaining first joint angle data at the current moment from a joint encoder corresponding to each joint in the supporting leg mechanism by using the leg odometer, and determining the first measurement state information of the leg-wheel hybrid robot at the current moment according to the first joint angle data.

14. The robot according to claim 12, wherein controlling the wheel odometer to determine the second measurement state information of the leg-wheel hybrid robot at the current moment based on the joint angle data corresponding to each of the rear wheels at the current moment and the radius of each of the rear wheels comprises:
obtaining second joint angle data corresponding to each of the rear wheels at the current moment from a joint encoder corresponding to each of the rear wheels by using the wheel odometer;
obtaining the radius of each of the rear wheels; and
determining the second measurement state information of the leg-wheel hybrid robot at the current moment according to the second joint angle data corresponding to each of the rear wheels and the radius of each of the rear wheels.

15. The robot according to claim 10, wherein determining the actual state information of the leg-wheel hybrid robot at the current moment according to the measurement state information and the predicted state information comprises:
fusing the measurement state information and the predicted state information to obtain the actual state information of the leg-wheel hybrid robot at the current moment.

16. The robot according to claim 10, wherein the measurement state information, the actual state information, the predicted state information, and the actual state information respectively comprise: position information, posture information, and speed information.

17. The robot according to claim 10, wherein determining the actual state information of the leg-wheel hybrid robot at the current moment comprises:
determining a predicted state offset of the leg-wheel hybrid robot at the current moment according to the inertial data collected by the inertial sensor at the current moment;
determining an actual state offset of the leg-wheel hybrid robot at the current moment according to the measurement state information and the predicted state offset; and
determining the actual state information of the leg-wheel hybrid robot at the current moment according to the actual state offset and actual state information of the leg-wheel hybrid robot at a previous moment.

18. The robot according to claim 10, the acts further comprising:
determining actual state information of the leg-wheel hybrid robot at a next moment according to the actual state information of the leg-wheel hybrid robot at the current moment.

19. A non-transitory computer-readable storage medium, configured to store a computer program, wherein the computer program causes a computer to perform a method for state determination of a robot, wherein the robot is a leg-wheel hybrid robot, and the leg-wheel hybrid robot comprises an inertial sensor, a leg odometer, and a wheel odometer, the method comprising:
determining predicted state information of the leg-wheel hybrid robot at a current moment according to inertial data collected by the inertial sensor at the current moment;
determining measurement state information of the leg-wheel hybrid robot at the current moment according to the leg odometer and the wheel odometer, respectively; and
determining actual state information of the leg-wheel hybrid robot at the current moment according to the measurement state information and the predicted state information.

20. The non-transitory computer-readable storage medium according to claim 19, wherein the determining the predicted state information of the leg-wheel hybrid robot at the current moment according to the inertial data collected by the inertial sensor at the current moment comprises:
processing the inertial data at the current moment collected by the inertial sensor according to a state transition parameter to obtain the predicted state information of the leg-wheel hybrid robot at the current moment.
